(19) United States
(12) Patent Application Publication
(10) Pub. No.: US 2009/0063959 A1
(43) Pub. Date: Mar. 5, 2009

(54) DOCUMENT CREATION SUPPORT SYSTEM

(76) Inventor: Zoran STEJIC, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/194,795

(22) Filed: Aug. 20, 2008

(30) Foreign Application Priority Data
Aug. 20, 2007 (JP) 2007-213803

(51) Int. Cl. G06F 17/00

(52) U.S. Cl. 715/255

(57) ABSTRACT

A document creation support system provides information regarding occurrence frequency of a user phrase and a related phrase for selected one or more of a plurality of document collections.

### CROSS-REFERENCE TO RELATED APPLICATIONS

This patent application is based on and claims priority under 35 U.S.C. §119 to Japanese Patent Application No. 2007-213803, filed on Aug. 20, 2007, in the Japanese Patent Office, the disclosure of which is hereby incorporated herein by reference.

### FIELD OF THE INVENTION

Example embodiments of the present invention relate generally to an apparatus, method, system, and computer program and product, each capable of supporting document creation, and more specifically to an apparatus, method, system, and computer program and product, each capable of supporting creation of a document by providing a phrase that is selected as appropriate based on the context in which the phrase is used.

### BACKGROUND

Recently, various kinds of documents are generated using one or more application programs that are installed on a user terminal such as a personal computer. When creating a document, the user may want to check whether a specific phrase that is selected by the user is appropriate in the context in which the phrase is used. For example, when the user is creating a document specifically for office use, the user is expected to use a phrase that is commonly used in the company. In another example, when the user is creating a document for public use, such as a webpage to be viewed by the general public, the user is expected to use a phrase that is widely recognized by the general audience. In order to determine appropriateness of the phrase in a given context, the user usually asks a person who has enough knowledge or refers to a dictionary. Alternatively, the user may send a search request to a search engine to have an idea of how frequently the phrase selected by the user is used in a number of documents exited on the network. However, there is no guarantee that the search result reflects the appropriateness of the phrase in the context in which the phrase is used, especially when the user intends to use the phrase in a document not prepared for the general audience.

Japanese Patent Application Publication No. 2005-209071 describes a technique, which extracts an index from a plurality of electronic documents, and generates a template using an index that is frequently used. This may be convenient if the user intends to use only a limited number of types of documents. However, with a large number of types of documents, the number of templates tends to increase that it may be cumbersome for the user to manage a large number of templates or select the most appropriate one from the large number of templates.

### SUMMARY

In view of the above or other limitations, the inventor of the present invention has discovered that, in order to select the phrase appropriate in the context in which the phrase is used, the context needs to be defined. Further, the inventor of the present invention has discovered that the context is definable using a collection of documents, such as a collection of documents on the Internet, a collection of documents in the company, a collection of documents created by the user, etc. If the context is defined by a collection of documents, the appropriateness of the phrase in the context in which the phrase is used is assumed to be proportional to the occurrence frequency of the phrase within the corresponding document collection.

Based on the above assumptions, example embodiments of the present invention include an apparatus, method, system, computer program and product each capable of providing information regarding occurrence frequency of a user phrase and a related phrase for selected one or more of a plurality of document collections.

In one example, a document creation support system includes: a storage device to store a plurality of document collections, each document collection storing a plurality of electronic documents that belong to the same group; a processor to generate a phrase check request for a user phrase according to a user instruction; a processor to obtain occurrence frequency of the user phrase for selected one or more of the plurality of document collections and to obtain occurrence frequency of a related phrase similar to the user phrase for the selected one or more of the plurality of document collections to generate a phrase check result; and a display device to display the phrase check result to the user.

In another example, a document creation support apparatus includes: a processor configured to generate a phrase check request for a user phrase according to a user instruction; a processor configured to obtain a phrase check result including occurrence frequency of the user phrase for selected one or more of a plurality of document collections and occurrence frequency of a related phrase similar to the user phrase for the selected one or more of the plurality of document collections; a storage device configured to store the phrase check result as the phrase check request for the user phrase is generated; and a display device configured to display the phrase check result to the user.

In another example, a method of supporting document creation includes: generating a phrase check request for a user phrase according to a user instruction; obtaining a phrase check result including occurrence frequency of the user phrase for selected one or more of a plurality of document collections and occurrence frequency of a related phrase similar to the user phrase for the selected one or more of the plurality of document collections; and displaying the phrase check result to the user.

In another example, a document creation support apparatus includes: a processor configured to obtain occurrence frequency of a user phrase for selected one or more of the plurality of document collections and to obtain occurrence frequency of a related phrase similar to the user phrase for the selected one or more of the plurality of document collections to generate a phrase check result.

In another example, a method of supporting document creation includes: obtaining occurrence frequency of a user phrase for selected one or more of the plurality of document collections and to obtain occurrence frequency of a related phrase similar to the user phrase for the selected one or more of the plurality of document collections to generate a phrase check result.

In addition to the above-described example embodiments, the present invention may be practiced in various other ways, for example, as a plurality of instructions, which causes a computer to perform a method of supporting document creation.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a configuration of a document creation support system according to an example embodiment of the present invention.

FIG. 2 is a schematic block diagram illustrating a functional structure of a server apparatus shown in FIG. 1, according to an example embodiment of the present invention;

FIG. 3 is a related phrase table stored in the server apparatus shown in FIG. 1, according to an example embodiment of the present invention;

FIG. 4 is a contents table stored in the server apparatus shown in FIG. 1, according to an example embodiment of the present invention;

FIG. 5 is a flowchart illustrating operation of processing a phrase check request, performed by the user terminal shown in FIG. 1, according to an example embodiment of the present invention;

FIG. 6 is a flowchart illustrating operation of processing a phrase check request, performed by the server apparatus shown in FIG. 1, according to an example embodiment of the present invention;

FIG. 7 is a schematic block diagram illustrating a functional structure of the user terminal shown in FIG. 1, according to an example embodiment of the present invention;

FIG. 8 is a phrase check list, stored in the user terminal shown in FIG. 1, according to an example embodiment of the present invention;

FIG. 9 is an appropriateness criteria list, stored in the user terminal shown in FIG. 1, according to an example embodiment of the present invention;

FIG. 10 is a screen that allows a user to input a phrase check request, displayed by the user terminal shown in FIG. 1, according to an example embodiment of the present invention;

FIG. 11 is an illustration of a screen including a phrase check result displayed by the user terminal shown in FIG. 1, according to an example embodiment of the present invention;

FIG. 12 is an illustration of a screen including a phrase check result displayed by the user terminal shown in FIG. 1, according to an example embodiment of the present invention;

FIG. 13 is an illustration of a screen including a phrase check result displayed by the user terminal shown in FIG. 1, according to an example embodiment of the present invention; and

FIG. 14 is an illustration of a phrase check result expressed in Extensible Markup Language (XML), according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

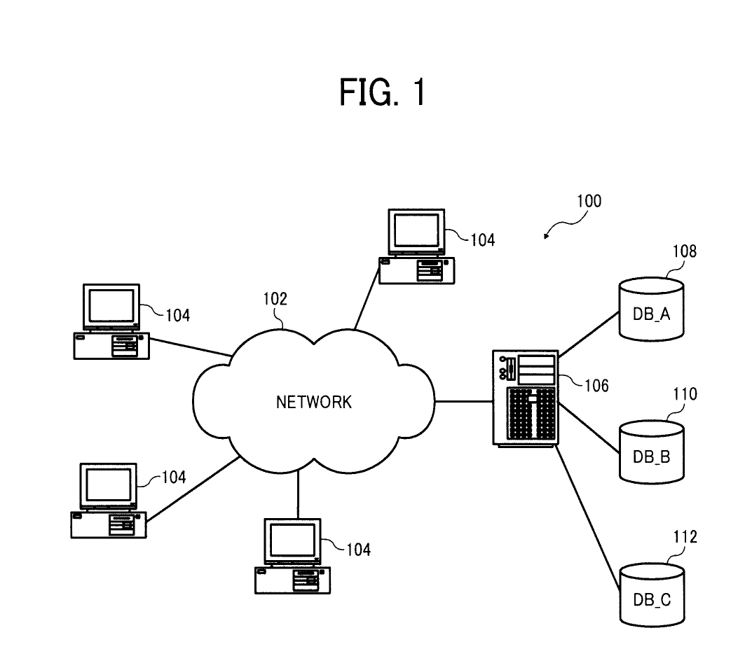

Referring now to FIG. 1, a document creation support system 100 is explained according to an example embodiment of the present invention. The document creation support system 100 includes a user terminal 104 and a server apparatus 106, which are connected via a network 102. As illustrated in FIG. 1, the user terminal 104 may include any number of user terminals. Further, the server apparatus 106 may include any number of server apparatuses. The network 102 may include any desired wired or wireless network including, for example, a local area network (LAN), wide area network (WAN), or the Internet.

In addition to the user terminal 104 and the server apparatus 106, the document creation support system 100 may include any number of storage devices each storing data. For example, as illustrated in FIG. 1, the document creation support system 100 may include a database (DB) A 108, a database (DB) B 110, and a database (DB) C 112. The DB A stores a plurality of electronic documents, or contents, that are available for public use through the network 102, which may be managed or provided by the Internet service provider, such as a webpage provided on the Internet. The DB B 110 stores a plurality of electronic documents, or contents, that may be accessed by a limited number of users. For example, the DB B 110 may be implemented by a company's database that can be accessed by employees of the company. The DB C 112 stores a plurality of electronic documents, or contents, that may be accessed by a specific user. For example, the DB C 112 may store a plurality of documents previously created by a specific user, such as a webpage or a database file generated by the specific user. Any one of the DB A 108, DB B 110, and DB C 112 may be implemented by any desired number of devices or databases each may be managed or provided by any desired number of devices or service providers.

In this example, the user terminal 104 may be implemented by any apparatus having a processor provided with a memory, a user interface, and a network interface, which is capable of generating or processing a request according to a user instruction, including, for example, a desktop computer, notebook computer, palmtop computer, personal digital assistance, etc. The server apparatus 106 may be implemented by any apparatus having a processor provided with a memory, and a network interface, which is capable of processing a request received from the user terminal 104. In this example, the server apparatus 106 may be implemented by a web server, which communicates with the user terminal 104 using the Hyper Text Transfer Protocol (HTTP).

Further, in this example, the user terminal 104 may generate various types of electronic documents using various types of application programs that are available for use. In one example, the user terminal 104 may generate a document for public use, such as a web page to be posted on the Internet, using a web page creation program. In another example, the user terminal 104 may generate a document for company use, such as a memo or a presentation document, using a word processing program or a presentation generation program. In another example, the user terminal 104 may generate a document for personal use, such as an email or a word document, using an email creation program or a word processing program. The document being created may be stored in any memory or storage provided in the user terminal 104. Alternatively, the document may be stored in any location on the document creation support system 100, for example, in any one of the DB A 108, DB B 110, and DB C 110.

When generating a specific type of document, the user at the user terminal 104 may want to check whether the user is using a phrase appropriate in the context in which the phrase is used. For example, even when referring to the same item, the user may need to express the item using a different phrase depending on the type of document being created or the intended audience of the document. In such case, the user may input or select a phrase to be checked (“the user phrase”) for its appropriateness, and initiate a phrase check request through the user terminal 104. When the phrase check request is generated by the user, the user terminal 104 may display information regarding the appropriateness of the user phrase in a selected document collection. In addition, the user terminal 104 may display a related phrase that is similar to the user phrase together with information regarding the appropriateness of the related phrase in the selected document collection. Based on information regarding the appropriateness of the user phrase and the related phrase, the user may determine whether to continue to use the user phrase that has been input or selected, or to replace the user phrase by the related phrase.

In one example, the user terminal 104 may be provided with a storage device, which stores, for each user phrase, a user phrase, one or more related phrases similar to the user phrase, and information indicating appropriateness of each one of the user phrase and the related phrases. When the phrase check request is received, the user terminal 104 may generate a graphical user interface (GUI) including information regarding appropriateness of the user phrase and the related phrase.

In another example, the user terminal 104 may send the phrase check request to the server apparatus 106 to request the server apparatus 106 to obtain information regarding appropriateness of the user phrase and the related phrase. When the phrase check request is received from the user terminal 104, the server apparatus 106 obtains a phrase check result that includes information indicating whether the user phrase is appropriate in a given context. Specifically, in this example, the server apparatus 106 may obtain occurrence frequency of the user phrase and the related phrase for each or selected one of the DB A 108, DB B 110, and DB C 112. The phrase check result may be sent to the user terminal 104 to be displayed to the user.

In this example, a phrase may correspond to a sequence of words or a part of a sentence such that any number of words may be contained in one phrase.

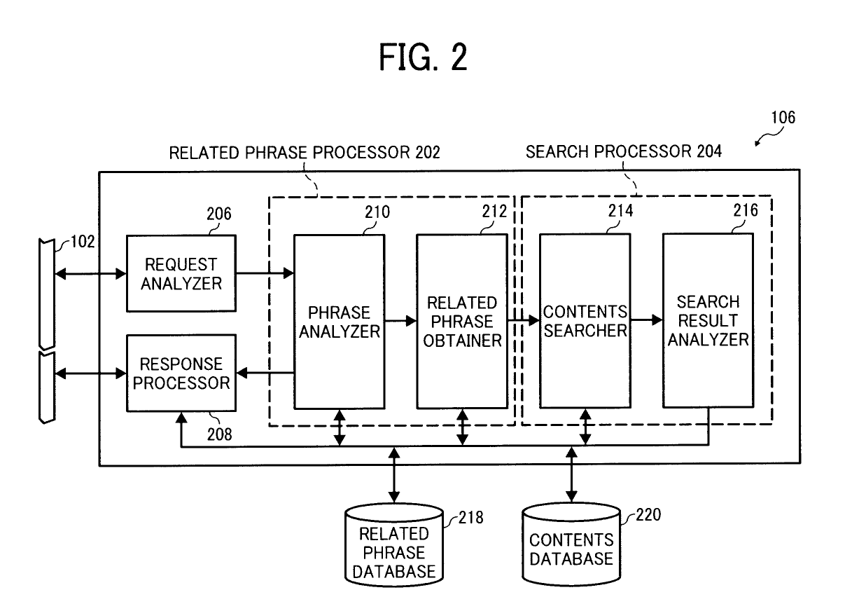

Referring to FIG. 2, a functional structure of the server apparatus 106 is explained according to an example embodiment of the present invention. The server apparatus 106 includes a related phrase processor 202 including a phrase analyzer 210 and a related phrase obtainer 212, a search processor 204 including a contents searcher 214 and a search result analyzer 216, a request analyzer 206, and a response processor 208. The search apparatus 106 may additionally include a related phrase database (DB) 218 and a contents database (DB) 220. Alternatively, the related phrase DB 218 and the contents DB 220 may be provided separately from the server apparatus 106. One or more components of the server apparatus 106 including, for example, the phrase analyzer 210, the related phrase obtainer 212, the contents searcher 214, and the search result analyzer 216, may be each or collectively implemented by a server program such as Servlet. The server program may function as a daemon or a background service. The server program may be provided with a common gateway interface (CGI).

The request analyzer 206 receives a user request from the user terminal 104 through the network 102, analyzes the user request, and calls a process module that is capable of performing processing requested by the user request. In this example, when the request analyzer 206 determines that the user request being received is a phrase check request, which requests to obtain a phrase check result for a user phrase selected by the user, the request analyzer 206 calls the related phrase processor 202. Specifically, the request analyzer 206 sends a request to the related phrase processor 202, which includes information regarding the user phrase as an argument, to cause the related phrase processor 202 to obtain information regarding a related phrase that is similar to the user phrase.

When the request is received, the related phrase processor 202 calls the phrase analyzer 210. The phrase analyzer 210 analyzes the user phrase using a dictionary, and divides the user phrase into one or more keywords, which may be referred to as an index, that are useful for search by eliminating the word that is not useful for search. For example, when the phrase contains an article such as “an” or “the”, such word is eliminated as it is not useful for search. In another example, the word in the plural form may be converted to the singular form. The phrase analyzer 210 sends the extracted keywords to the related phrase obtainer 212.

For each keyword being obtained, the related phrase obtainer 212 searches through the related phrase DB 218 to obtain one or more related phrases that are stored in a corresponding manner with the keyword. The related phrase obtainer 212 sends one or more related phrases together with the user phrase to the search processor 204.

The search processor 204 accesses the contents database 220 to search for one or more contents including the user phrase and/or the related phrase to generate a search result. For example, the contents searcher 214 may be implemented by a relational database using structured query language (SQL) or an object oriented database. The search result may be further sent to the search result analyzer 216.

Additionally or alternatively, the contents searcher 214 may function as an intermediate server, which utilizes a search function provided by a search engine provided by the service provider such as Google or Yahoo!. In such case, the contents searcher 214 receives the user phrase and the related phrase, and sends the user phrase and the related phrase to the search engine to request to perform searching using the user phrase and the related phrase. When the request is received, the search engine may access the contents database 220, or any other contents database managed by the service provider, to search for one or more contents that includes the user phrase and/or the related phrase. The contents searcher 214 receives a search result from the search engine, and sends the search result to the search result analyzer 216.

Further, in this example, the contents searcher 214 may search for one or more documents including the user phrase and/or the related phrase, for each one or more of the categories specified by the user or set by default. In one example, when the phrase check request includes information regarding a specific category selected by the user, the contents searcher 214 identifies a database that corresponds to the selected category by the uniform resource identifier (URI), and sends a query to the identified database to obtain a search result indicating occurrence frequency of the user phrase and the related phrase for the selected category. Alternatively, when the phrase check request includes no information regarding the category, the contents searcher 214 may send a query to a plurality of databases that may be set by default to obtain a search result indicating occurrence frequency of the user phrase and the related phrase for each one of the plurality of categories.

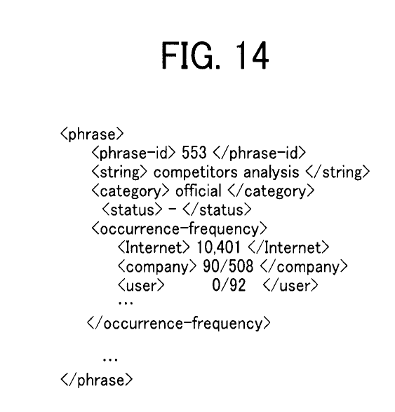

The search result analyzer 216 may analyze the search result received from the contents searcher 214 to generate a phrase check result. For example, when the search result analyzer 216 receives the search result, which may be written in a structure language such as XML as illustrated in FIG. 14, the search result analyzer 216 may generate a phrase check result using document object model (DOM) or simple API for XML (SAX). The phrase check result generated by the search result analyzer 216 is sent to the response processor 208. The response processor 208 sends the phrase check result to the user terminal 104 through the network 102 in response to the phrase check request.

Further, in this example, the occurrence frequency of the phrase may be obtained in various ways using any desired known technique. In one example, the occurrence frequency of the phrase may be obtained based on a word frequency, which is the number of times that phrase occurs in each document in the document collection having the selected category. In another example, the occurrence frequency of the phrase may be obtained based on a document frequency, which is the number of documents, in the document collection having the selected category, the phrase occurs in. Further, the word frequency or document frequency may be further analyzed based on the total number of documents in the document collection having the selected category.

In another example, any desired search technique may be used, for example, depending on the total number of documents stored in the database. For example, in order to obtain occurrence frequency for the DB A 108, one or more documents including the user phrase and the related phrase may be searched. In order to obtain occurrence frequency for the DB B 110 or the DB C 112, one or more documents including the user phrase or the related phrase may be searched in addition to the one or more documents including the user phrase and the related phrase.

The server apparatus 106 may be implemented in various other ways. For example, the sever apparatus 106 may be provided for each one of the DB A 108, DB B 110, and DB C 112.

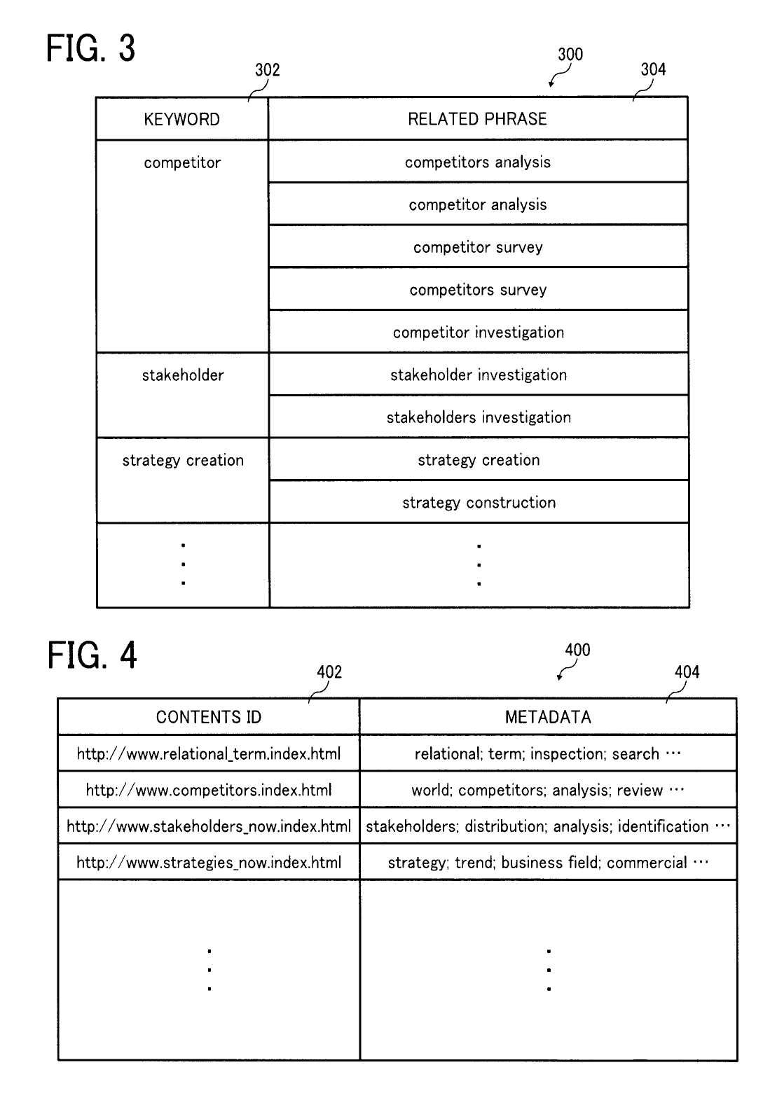

Referring now to FIG. 3, a related phrase table 300, which may be stored in the related phrase DB 218, is explained according to an example embodiment of the present invention. The related phrase table 300 includes a field 302 storing a keyword previously registered, and a field 304 storing one or more related phrases with respect to the registered keyword. In this example, the related phrase includes any phrase containing the keyword and a word that is most likely to be used together with the keyword. Further, in this example, the server apparatus 106 is assumed to manage the related phrase table 300. For example, the server apparatus 106 may periodically obtain metadata from the contents database 220, and creates or updates a list of related phrases for each keyword, for example, using proximity search technology that may determine similarity between phrases in terms of semantic similarity in addition to string similarity. Alternatively, the related phrase table 300 may be updated according to a user instruction input by the user.

Referring to FIG. 4, a contents table 400, which may be stored in the contents database 220, is explained according to an example embodiment of the present invention. The contents table 400 includes a field 402 storing a contents identifier (ID), and a field 404 storing metadata for the contents identified by the contents ID. As illustrated in FIG. 4, the contents ID corresponds to a location of the contents, which is expressed using Uniform Resource Identifier (URI). The metadata includes a plurality of keywords that may be subject for searching by the search engine, which is extracted from the contents. For example, in the example case of the contents identified by the URI of http://www.relational_term.index.html, the metadata includes a plurality of keywords including “relational”, “term”, “inspection”, “search”, etc., which may be previously extracted as the word reflecting the contents of the document. Further, in this example, the contents database 400 may additionally include a field storing a category of the document. In this example, the category may by defined by the database in which the contents is stored, such as information indicating which one of the DB A 108, DB B 110, and DB C 112 stores the contents. With the contents database 400, searching may be performed more efficiently.

Alternatively, each filed of the contents table 400 may store information as an instance of objected oriented database (OODB). In alternative to the contents table 400, information regarding the phrases used in a plurality of documents may be stored in the form of structural data such as HTML or XML.

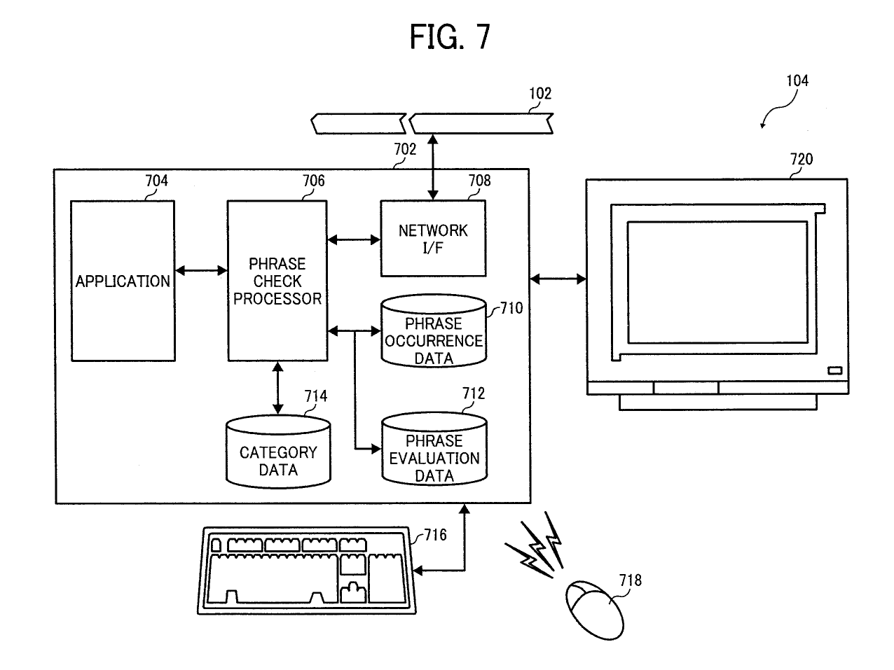

Referring now to FIG. 7, an example structure of the user terminal 104 is explained according to an example embodiment of the present invention. The user terminal 104 of FIG. 7 includes an information processing device 702, a display device 720, an input device 716 such as a keyboard, and a pointing device 718 such as a mouse.

The information processing device 702 may be implemented by a processor such as a central processing unit (CPU) provided with a memory. The memory may include, but not limited to, a read only memory (ROM), random access memory (RAM), hard disk drive (HDD), or removable memory including, for example, an optical disc such as MO, CD-ROM, DVD, etc. As described above referring to FIG. 1, the information processing device 702 provides a function of generating a phrase check request and sending the phrase check request to the server apparatus 106 via the network 102. When a phrase check result is received, the information processing device 702 may cause the display device 720 to display the phrase check result to the user. Further, the information processing device 702 may replace a user phrase that has been checked for its appropriateness with a related phrase provided by the phrase check result upon a user instruction.

In order to provide the above-described function, the information processing device 702 mainly includes an application 704, a phrase check processor 706, a network interface (I/F) 708, phrase occurrence data 710, phrase evaluation data 712, and category data 714.

The application 704 includes a document generating program that allows the user terminal 104 to create a document such as a word processing program, or a web browser that allows the user terminal 104 to display information obtained from the server apparatus 106 such as Internet Explorer, Mozilla, Opera, Netscape Navigator, etc.

The phrase check processor 706 may be provided as a plug-in program, add-in program, or macro-object, which may be used together with an application program of the application 704. The phrase check processor 706 processes the phrase check request, which may be input by the user through the application program of the application 704. For example, when the phrase check request is received from the user through the input device 716 or the pointing device 718, the phrase check processor 706 processes the phrase check request using any one of the phrase occurrence data 710, phrase evaluation data 712, and category data 714, which may be managed by the phrase check processor 706. Alternatively, the phrase check processor 706 may obtain information from the outside, such as from the server apparatus 106, to process the phrase check request.

The network I/F 708 allows the user terminal 104 to communicate with another apparatus such as the server apparatus 106 via the network 102. In one example, the network I/F 708 sends the phrase check request to the server apparatus 106 via the network 102. In another example, the network I/F 708 receives the phrase check result from the server apparatus 106 via the network 102.

The phrase occurrence data 710 stores information indicating appropriateness of a user phrase, which may be obtained from the server apparatus 106. For example, in response to the phrase check request that requests for information indicating appropriateness of a user phrase, the phrase check processor 706 may receive a phrase check result from the server apparatus 106, which includes information regarding occurrence frequency of the user phrase and the related phrase. The phrase check result being received is further stored in the phrase occurrence data 710 for later use, such as when displaying the phrase check result to the user. As the user initiates the phrase check request for a new phrase, the phrase occurrence data 710 constantly adds the phrase check result of the new phrase. In this manner, the phrase occurrence data 710 may be able to provide more information useful to the user.

The phrase evaluation data 712 may store information defining criteria that may be used to evaluate the appropriateness of the user phrase or the related phrase. For example, as described below referring to FIG. 9, the phrase evaluation data 712 may rank the appropriateness of the phrase based on its occurrence frequency. Further, in the process of obtaining the occurrence frequency, a specific collection of documents may be weighted. For example, officially approved documents may be set so as to have a higher weight. In another example, weight of the documents, such as the documents provided via the Internet, may be determined based on the site providing the document.

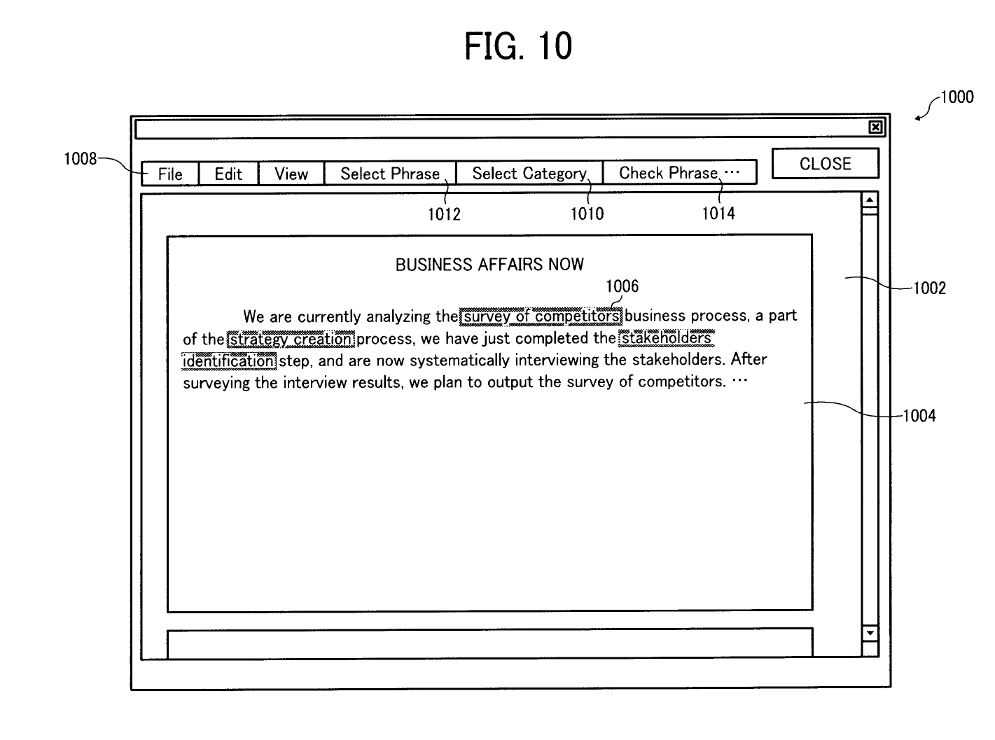

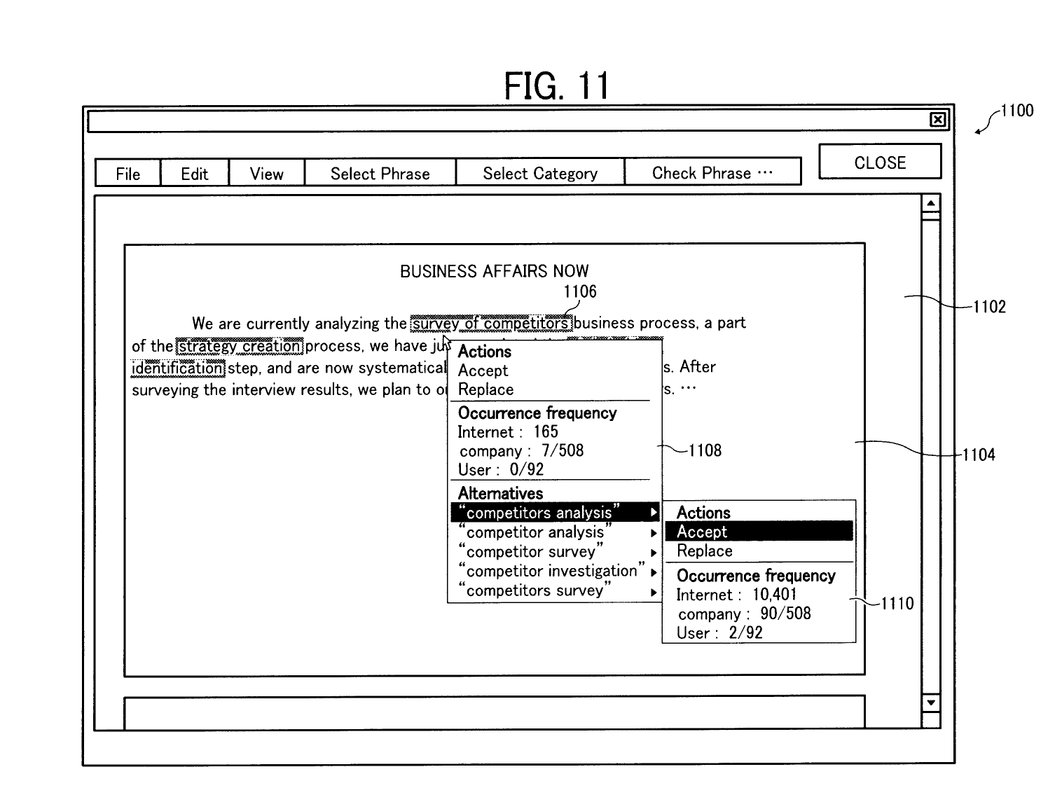

The category data 714 may store information indicating one or more categories that may be specified by the user or set by default. In this example, the category is assumed to correspond to a collection of documents, which defines the context in which the phrase is used. For example, the category data 714 may be set so as to have one or more categories respectively corresponding to one or more databases provided on the document creation support system 100 of FIG. 1. Specifically, the category “public documents” may be set so as to correspond to a plurality of documents stored in the DB A 108. The category “official documents” may be set so as to correspond to a plurality of documents stored in the DB B 110. The category “personal use” may be set so as to correspond to a plurality of documents stored in the DB C 112. The category data 714 may be expressed in the form of table or XML. Further, the category data 714 may be referred by the phrase check processor 706 to generate a GUI to be displayed to the user through the display device 720. For example, as described referring to FIG. 10, the “select category menu” may be generated based on the category data 714, which displays a list of categories. In another example, as described referring to any one of FIGS. 11, 12, and 13, the GUI may display information regarding the occurrence frequency for each category of “Internet” that corresponds to the “public documents”, “Company” that corresponds to “official documents”, and “User” that corresponds to “personal use”.

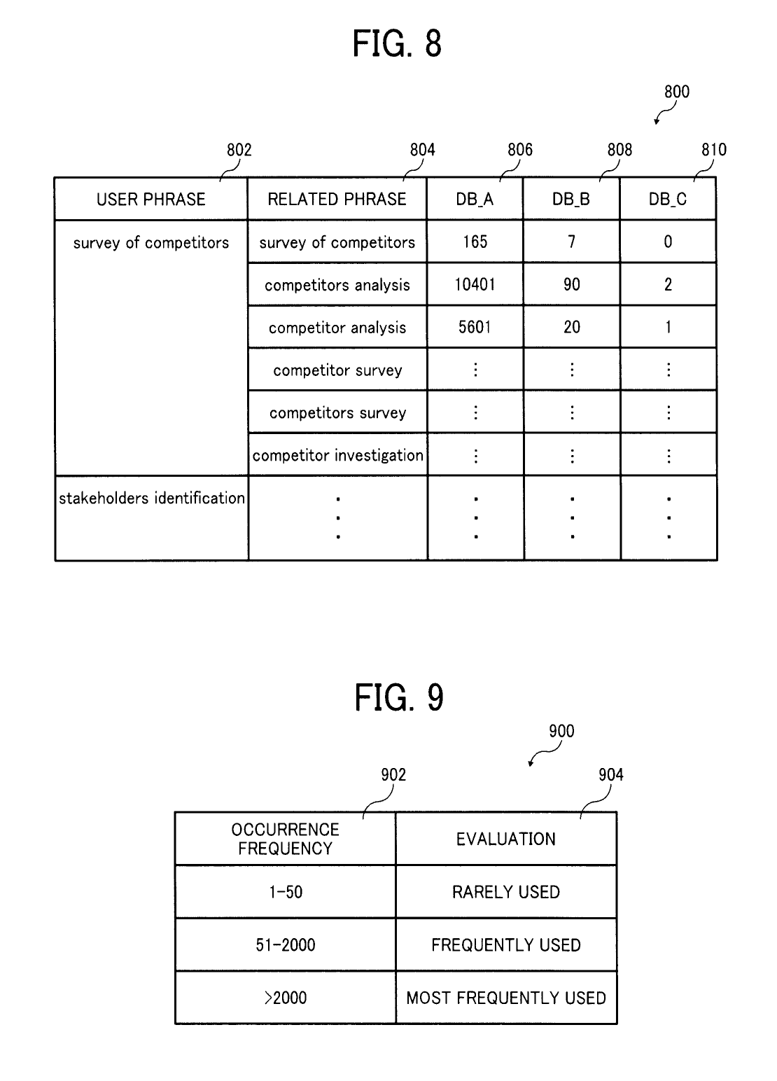

Referring now to FIG. 8, a phrase check list 800, which may be stored in the phrase occurrence data 710, is explained according to an example embodiment of the present invention. The phrase check list 800 includes a field 802 storing a user phrase, a field 804 storing the user phrase and one or more related phrases, a field 806 storing occurrence frequency obtained using a collection of documents stored in the DB A 108, a field 808 storing occurrence frequency obtained using a collection of documents stored in the DB B 110, and a field 810 storing occurrence frequency obtained using a collection of documents stored in the DB C 112.

For example, in the example case of the user phrase “survey of competitors”, information regarding the occurrence frequency of the user phrase “survey of competitors” being obtained for the “public documents” category, or a collection documents stored in the DB A 108, is stored. This phrase check result indicates that the user phrase is used in the “public documents” category with occurrence frequency of 165. In addition to the occurrence frequency of the user phrase, information regarding the occurrence frequency of the related phrase being obtained for the “public documents” category, or a collection of documents stored in the DB A 108, is stored. This phrase check result indicates that the related phrase “competitors analysis” is used in the “public documents” category with occurrence frequency of 10401. The phrase check result further indicates that the related phrase “competitor analysis” is used on the Internet with occurrence frequency of 5601.

The phrase check result further indicates that the occurrence frequency that corresponds to the “official documents” category, or the DB B 110, is 7, 90, and 20 respectively for the user phrase “survey of competitors”, the related phrase “competitors analysis”, and the related phrase “competitor analysis”. The phrase check result further indicates that the occurrence frequency that corresponds to the “personal use” category, or the DB C 112, is 0, 2, and 1 respectively for the user phrase “survey of competitors”, the related phrase “competitors analysis”, and the related phrase “competitor analysis”.

In alternative to the above-described example case of providing the phrase occurrence data 710 in the form of the phrase check list 800, the phrase occurrence data 710 may be provided in XML.

Referring now to FIG. 9, an appropriateness criteria list 900, which may be stored in the phrase evaluation data 712, is explained according to an example embodiment of the present invention. The appropriate criteria list 900 includes a field 902 storing information regarding document frequency of the phrase, and a field 904 storing information that may be used to evaluate the appropriateness of the phrase based on the document frequency. In this example, as illustrated in FIG. 9, the appropriateness of the phrase is determined based on the number of times the phrase occurs in each document in the document collection. More specifically, referring to FIG. 9, when the occurrence frequency of the phrase is between 1 and 50, it is determined that the phrase is rarely used. When the occurrence frequency of the phrase is between 51 and 2000, it is determined that the phrase is frequently used. When the occurrence frequency of the phrase is greater than 2000, it is determined that the phrase is most frequency used.

In this example, the appropriateness criteria list 900 may be generated for each one of the categories that are defined by the category data 714. Alternatively, the appropriateness criteria list 900 may be generated collectively for all categories. When the appropriateness criteria list 900 refers to all categories of the contents, the document frequency that is determined as “frequently used” as described above may further indicate that the appropriateness of the phrase may vary from category to category. Further, the document frequency that is determined as “most frequently used” may further indicate that the phrase is widely used despite of the context in which the phrase is used, or the category in which the phrase is used. When it is determined that the appropriateness of the phrase varies from category to category, the phrase check processor 706 may further evaluate the phrase using criteria other than the criteria based on the number of times that phrase occurs in the document collection. The appropriateness criteria list 900 may be set by default or set according to the user preference.

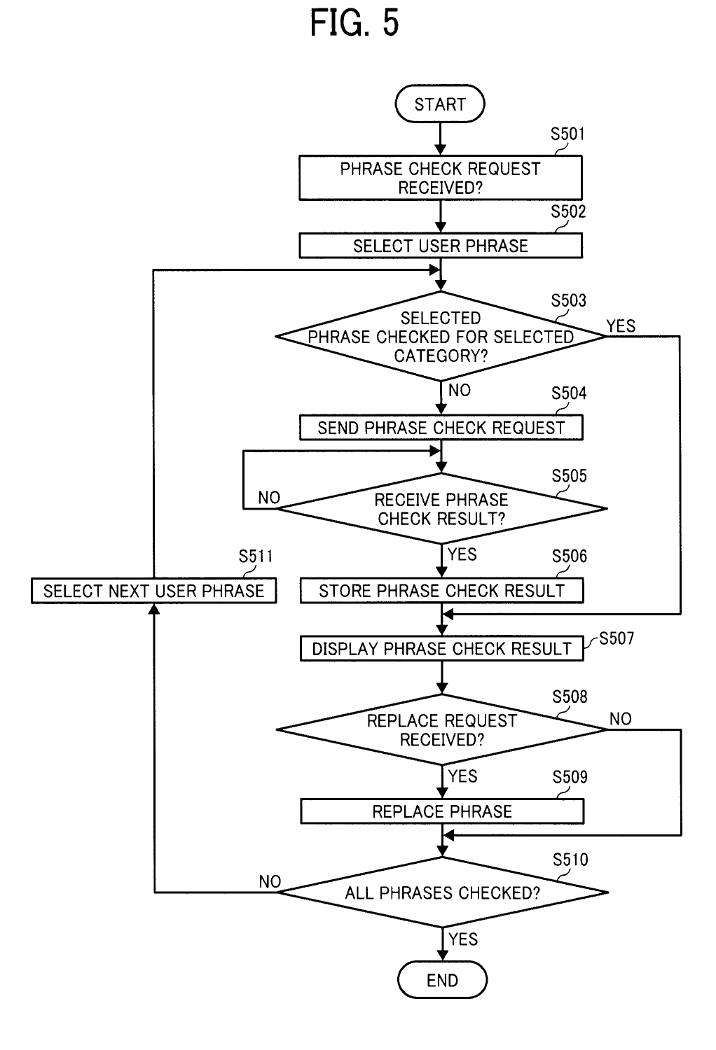

Referring now to FIG. 5, operation of processing a phrase check request, performed by the user terminal 104, is explained according to an example embodiment of the present invention.

At S501, a user selects a user phrase to be checked for its appropriateness in a given context. For example, the user may select at least one of phrases being displayed on the user interface as a user phrase. Alternatively, the user may input a user phrase, for example, in an entry field provided by a form displayed by the user terminal 104. The user phrase may be registered in a query cue or waiting list for further processing. In addition to the user phrase, the user may select one or more categories to be searched as a selected category. In this example, the category is assumed to be selected so as to reflect a context of the document being created by the user.

At S502, the phrase check processor 706 selects one user phrase, if a plurality of user phrases are input or selected.

At S503, the phrase check processor 706 determines whether the selected user phrase has been previously checked for its appropriateness for a selected category, for example, by referring to the cookie or referring to the phrase check list 800 of the phrase occurrence data 710. When it is determined that the selected user phrase has been checked for the selected category (“YES” at S503), the operation proceeds to S507. At S507, the phrase check processor 706 may display information regarding the phrase check result, such as the occurrence frequency or the evaluation result, to the user through the display device 720. When it is determined that the selected user phrase has not been checked for the selected category (“NO” at S503), the operation proceeds to S504.

At S504, the phrase check processor 706 generates a phrase check request including the selected user phrase, and send the phrase check request to the server apparatus 106 through the network 102. The phrase check request may additionally include information regarding the selected category.

At S505, the phrase check processor 706 determines whether a phrase check result is received from the server apparatus 106 in response to the phrase check request. When it is determined that the phrase check result is received (“YES” at S505), the operation proceeds to S506. When it is determined that the phrase check result is not received (“NO” at S505), the operation repeats S505 to wait for the phrase check result or a response from the server apparatus 106 at least for a predetermined time period. When the result or the response is not received for the predetermined time period, the user terminal 104 may display an error message to the user.

At S506, the phrase check processor 706 stores information of the phrase check result in the phrase occurrence data 710, for example, in the phrase check list 800 of FIG. 8.

At S507, the phrase check processor 706 refers to the phrase check list 800 to generate a geographical user interface (GUI) based on the phrase check result obtained in response to the phrase check request. Specifically, in this example, the phrase check processor 706 associates a field corresponding to the selected user phrase, which is displayed through the display device 720, with the phrase check result obtained for the selected user phrase to cause the phrase check result to be displayed automatically or in response to a user instruction. As described below referring to any one of FIGS. 11, 12, and 13, the GUI may be displayed in the form of a hyperlink, pop-up window, or pop-up menu.

At S508, the phrase check processor 706 determines whether a request for replacing the user phrase with a related phrase is received from the user. When it is determined that the request for replacing is received (“YES” at S508), the operation proceeds to S509. When it is determined that the request for replacing is not received (“NO” at S508), the operation proceeds to S510.

At S509, the phrase check processor 706 causes the application 704 to replace the selected user phrase with the related phrase selected by the user.

At S510, the phrase check processor 706 refers to the query cue or waiting list to determine whether all user phrases selected by the user has been checked. When it is determined that all user phrases have been checked (“YES” at S510), the operation ends. When it is determined that all user phrases have not been checked (“NO” at S510), the operation proceeds to S511 to select a user phrase to be processed.

The operation of FIG. 5 may be performed in various other ways. For example, instead of determining whether the user phrase has been previously checked at S503, the operation may proceed to S504. In another example, at S503, the phrase check processor 706 may additionally determine whether the contents DB 220 has been updated since the last time when the user phrase has been checked. When it is determined that the contents DB 220 has been updated, the operation may proceed to S504 to obtain a phrase check result for the user phrase even when the phrase check result has been previously obtained. This causes the document frequency of the user phrase to accurately reflect the context in which the user phrase is used, which is defined by the document collection of the selected category that may change over time as the documents are modified, added or deleted. In another example, at S503, the phrase check processor 706 may additionally determine whether the category data 714 has been changed since the last time when the user phrase has been checked. When it is determined that the category data 714 has been changed, the operation may proceed to S504 to obtain a phrase check result for the user phrase even when the phrase check result has been previously obtained. This causes the document frequency of the user phrase to accurately reflect the context in which the user phrase is used, which is defined by the document collection of the selected category that may change over time as the documents are modified, added or deleted. In another example, S508 of determining whether the request for replacing may not be performed, especially when the user phrase has been input directly using the form.

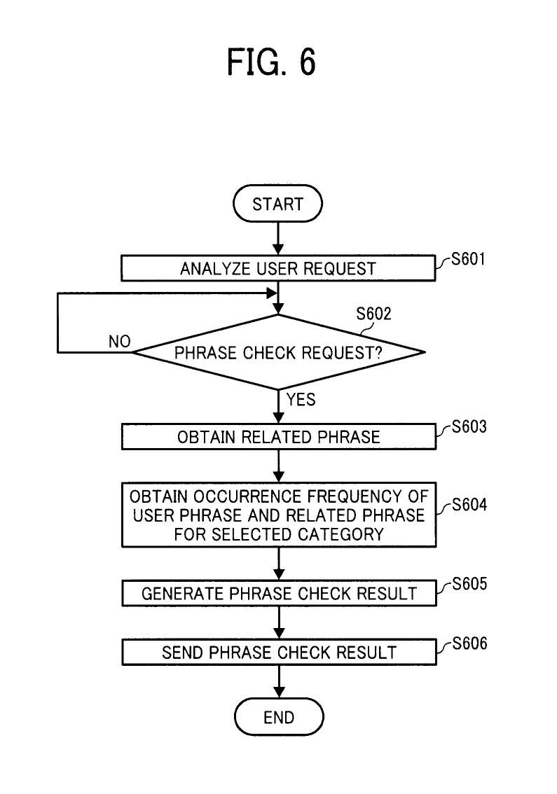

Referring now to FIG. 6, operation of processing a phrase check request, performed by the server apparatus 106, is explained according to an example embodiment of the present invention.

At S601, the request analyzer 206 receives a user request from the user terminal 104 and analyzes the user request.

At S602, the request analyzer 206 determines whether the user request is a phrase check request. When it is determined that the user request is the phrase check request (“YES” at S602), the operation proceeds to S603. When it is determined that the user request is not the phrase check request (“NO” at S602), the operation repeats S602. In such case, the user request is processed by a corresponding service of the server apparatus 106.

At S603, the related phrase processor 202 analyzes the phrase check request to obtain one or more keywords from the user phrase, and obtains one or more related phrases that is similar to the user phrase, for example, by referring to the related phrase DB 218.

At S604, the related phrase processor 202 sends a request for searching, which includes information regarding the user phrase and the related phrase, to the search processor 204. When the search request is received, the search processor 204 obtains occurrence frequency of each one of the user phrase and the related phrase. For example, in the example case of obtaining occurrence frequency of the user phrase, the search processor 204 searches through the contents DB 220 for one or more contents that contains the user phrase for one or more of specific categories specified by the phrase check request or set by default.

At S605, the response processor 206 generates a phrase check result based on the search result.

At S606, the response processor 206 sends the phrase check result to the user terminal 104 through the network 102, and the operation ends.

Referring now to FIG. 10, a GUI 1000, which may be displayed by the user terminal 104 is explained according to an example embodiment of the present invention. As illustrated in FIG. 10, the GUI 1000 displays a window 1002 including an input field 1004, which allows the user to input a text string to create a document. The GUI 1000 additionally includes a plurality of menus 1008 including the “File” menu, the “Edit” menu, the “View” menu, the “Select Phrase” menu 1012, the “Select Category” menu 1010, and the “Check Phrase” menu 1014, which are displayed to the user together with the input field 1004.

When the user wishes to check whether one or more phrases input by the user in the input field 1004 are appropriate in the context in which the phrases are used, the user may select the “Select Phrase” menu 1012 from the menu 1008 to cause the phrase check processor 706 to be executed. Upon execution, the application 704 may be switched from a normal mode to a phrase selection mode to allow the user to select one or more phrases from the input field 1004. In the phrase selection mode, the user may select any number of phrases, for example, by specifying a portion of the text string by clicking with the mouse 718 for a predetermined number of times. When the portion is specified, the user terminal 104 may change a color of the specified portion or the user phrase as illustrated in FIG. 10. In the example case shown in FIG. 10, the user selects three user phrases.

The selected user phrases are registered in a query cue or a waiting list at least until further instruction from the user is received. For example, when the user generates a phrase check request, the user phrases are sent to the server apparatus 106. The user phrases may be sent, one by one, to the server apparatus 106. Alternatively, the user phrases may be sent in batch.

Referring to FIG. 10, after selecting the user phrase, the user may further select the “Select Category” menu 1010 to select one or more categories to be used for searching. When the “Select Category” menu 1010 is selected, one or more categories that are previously registered in the category data 714 are displayed, for example, as a pull-down menu. When the user selects one or more of the categories, information regarding the selected category is sent together with the phrase check request to the server apparatus 106. Based on the selected category, the server apparatus 106 may select at least one of the databases 108, 110, and 112 to perform searching. Alternatively, even when the user does not select any one of the categories, the server apparatus 106 may search for one or more documents for each one or more of categories that are previously set. Alternatively, even when the user selects one or more categories, the server apparatus 106 may search for one or more documents for any number of additional databases according to the default settings.

Still referring to FIG. 10, the user may further select the “Check Phrase” menu 1014 to select whether to initiate the phrase check request or cancel the phrase check request. For example, when the “Check Phrase” menu 1014 is selected, the user terminal 104 may display the “Check Phrase” button that requests for processing the phrase check request, and the “Reset” button that requests canceling of the phrase check request, for example, in a pull-down menu. When the “Check Phrase” button is selected by the user, the user terminal 104 may send the phrase check request including information regarding one or more user phrases or one or more selected categories.

When the user terminal 104 receives the phrase check result from the server apparatus 106 in response to the phrase check request, in one example, the user terminal 104 may generate a hyperlink for each user phrase being selected, which links to a GUI including the phrase check result. The GUI may be written in HTML or XML based on the phrase check result. Alternatively, the user terminal 104 may generate a pop-up window or pop-up menu, which is to be displayed on a coordinate position closely located to the user phrase or the portion being selected. The pop-up window or menu may be displayed by automatically or according to a user instruction.

Further, in this example, when the phrase check result is received, the user terminal 104 may change appearance of the user phrase or the portion being selected by the user to notify the user that the phrase check result is received. For example, the user terminal 104 may change the color of the user phrase or the portion being selected by the user to notify the user that the phrase check result is received. Alternatively, the user terminal 104 may underline the user phrase to notify the user that the phrase check result is received.

Referring now to any one of FIGS. 11, 12, and 13, a GUI including a phrase check result, which may be displayed by the user terminal 104, is explained according to an example embodiment of the present invention.

FIG. 11 illustrates an example case in which the phrase check result is displayed in the form of pull-down menu. Referring to FIG. 11, a window 1102 includes an input field 1104 for displaying a text string input by the user that corresponds to the input field 1004 of FIG. 10. The user phrase 1106 being selected, which corresponds to the user phrase 1006 of FIG. 10, may be shown in a color different from the color of the user phrase 1006 as the phrase check result is received. When the user instructs the user terminal 104 to display the phrase check result for the user phrase 1106, for example, by moving a cursor to the portion overlapping the user phrase 1106 and right-clicking or double-clicking with the mouse 718, the pop-up menu 1108 is displayed.

Referring to FIG. 11, the pop-up menu 1108 includes the “Actions” item which allows the user to select whether to accept the user phrase 1106 or replace the user phrase 1106, the “Occurrence Frequency” item displaying the occurrence frequency of the user phrase 1106 for each category of the “Internet”, “Company”, and “User”, and the “Alternatives” item displaying a list of related phrases that are similar to the user phrase. Based on the occurrence frequency of the user phrase 1106, the user may determine whether to accept or replace the user phrase 1106. When the user determines to accept the user phrase 1106, the user is expected to select the “Accept” item of the “Actions” item.

When the user determines to replace the user phrase 1106, the user may further view the occurrence frequency of one or more of the related phrases listed in the “Alternatives” item. For example, when the user selects the related phrase “competitors analysis”, the pop-up menu 1110 may be displayed, which includes information regarding the occurrence frequency of the related phrase “competitors analysis” for each category of “Internet”, “Company”, and “User”. Based on the occurrence frequency, the user may determine whether to accept the related phrase “competitors analysis” to replace the user phrase 1106 with the related phrase “competitors analysis”. When the request for replacing is input by the user, the phrase check processor 706 may cause the application 704 to replace the user phrase 1106 with the related phrase “competitors analysis” by cut and paste.

The pop-up menu 1108 may be generated based on Java or Java Script. For example, PopuMenu class, which causes the show( ) method to be executed in response to a user instruction, may be used.

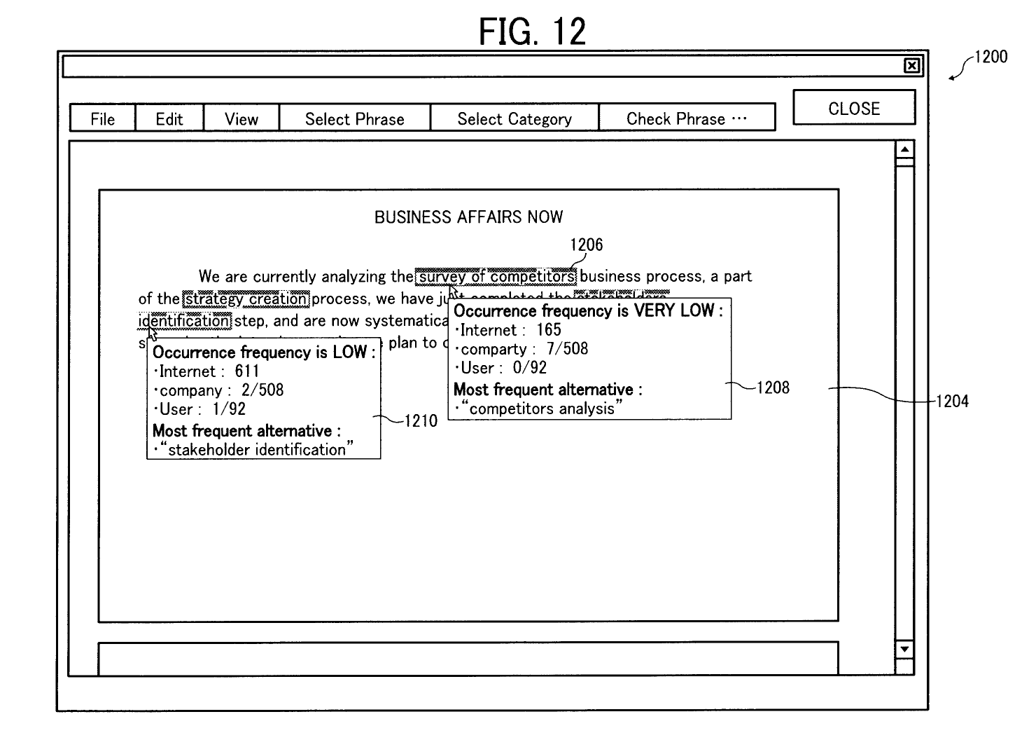

FIG. 12 illustrates an example case in which the phrase check result is displayed in the form of pop-up window. For example, referring to FIG. 12, when the user selects the user phrase 1206 that corresponds to the user phrase 1006 of FIG. 10, for example, by moving a curser and right-clicking with the mouse 718, the pop-up window 1208 may be displayed. The pop-up window 1208 may be implemented by Windows class based on Java. Alternatively, the pop-up window 1208 may be implement based on any other desired kind of object oriented programming.

Referring to FIG. 12, the pop-up window 1208 includes information regarding the occurrence frequency of the user phrase 1206 for each category of “Internet”, “Company”, and “User”, and information regarding the related phrase that is selected as having the highest occurrence frequency. Based on information provided by the pop-up window 1208, the user may determine whether to continue to use the user phrase 1206, or replace the user phrase 1206 with the related phrase “competitors analysis”.

In a substantially similar manner, when the user selects the user phrase “stockholders identification”, for example, by moving a curser and right-clicking with the mouse 718, the pop-up window 1210 may be displayed to provide information regarding the occurrence frequency of the user phrase “stockholders identification” and information regarding the related phrase that is most frequently used.

Further, in this example, when the user moves the cursor away from the user phrase 1206, the pop-up window 1208 may be automatically closed. By providing the phrase check result in the form of pop-up window, the area taken by the pop-up window may be made smaller, for example, when compared with the above-described example case of FIG. 11. Further, since the user terminal 104 displays only the related phrase that is most frequently used as an alternative, the user does not have to determine which one of the related phrases should be used.

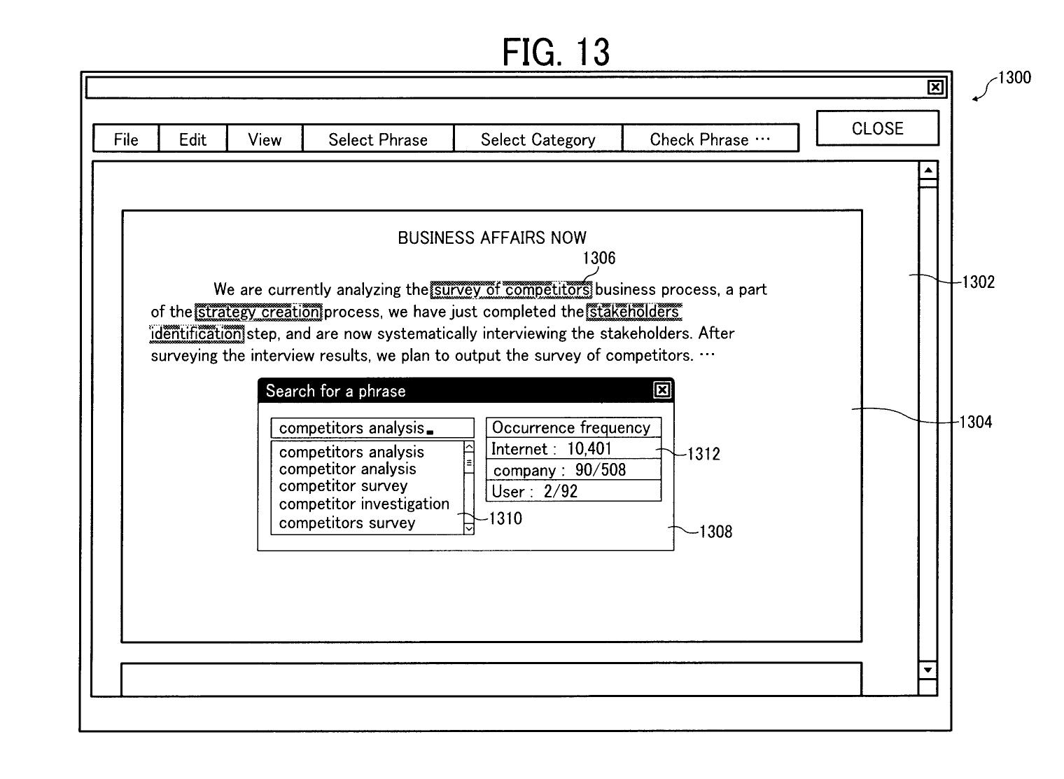

FIG. 13 illustrates an example case in which the phrase check result is displayed in the form of pop-up window including a list box. For example, when the user selects the user phrase 1306 that corresponds to the user phrase 1006 of FIG. 10, the user terminal 104 displays the pop-up window 1308 including a list box 1310 and a table 1312. The list box 1310 lists a plurality of related phrases similar to the user phrase 1306. When the user selects one of the related phrases, for example, the related phrase “competitors analysis”, from the list box 1310, the occurrence frequency of the related phrase “competitors analysis” for each category of “Internet”, “Company”, and “User” is displayed in the table 1312. Based on information provided by the pop-up window 1308, the user may select the related phrase to replace the user phrase 1306.

In order to display the occurrence frequency for the related phrase that has been selected, DOM technique may be used to search for a XML document generated for the selected related phrase, and display the occurrence frequency on the table 1312.

As described above referring to any one of FIGS. 1 to 14, as the occurrence frequency of the user phrase is obtained for one or more categories, or one or more document collections, the appropriateness of the user phrase is obtained while taking into account the context in which the user phrase is used. Further, since the document support creation system 100 provides one or more related phrases similar to the user phrase, the user may easily replace the user phrase with the related phrase that is more appropriate in the given context. Without asking the person or referring to the dictionary, the user may create a document using the phrase that is most appropriate in a given context.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, the document creation support system 100 of FIG. 1 may be used in various ways other than creating a specific document. In one example, the user may use the document creation support system 100 when translating. For example, the user may translate a document from one language to another language using machine translation, and check whether the phrases used in the translated document are appropriate. In such case, since the user is assumed to be not familiar with the language, the document creation support system 100 may be set so as to automatically replace a user phrase with the related phrase that is most frequently used, when the user phrase is not most frequently used.

In another example, the user may use the document creation support system 100 when editing a collection of different parts of the same document, or a collection of different versions of the same document, which may be jointly created by a plurality of authors. In such case, the user may use the document creation support system 100 to unify the terminology used by different authors.

In another example, elements and/or features of different illustrative embodiments may be combined with each other and/or substituted for each other within the scope of this disclosure and appended claims. Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, involatile memory cards, ROM (read-only-memory), etc. Further, the above-described and other methods of the present invention may be written using any desired programming language including the legacy programming language or the object-oriented programming language, such as the assembler, C, C++, Java, Java Beans, Java Applet, Java Script, Perl, Ruby, etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

What is claimed is:

1. A document creation support system, comprising:
a storage device configured to store a plurality of document collections, each document collection storing a plurality of electronic documents that belong to the same group;
a processor configured to generate a phrase check request for a user phrase according to a user instruction;
a processor configured to obtain occurrence frequency of the user phrase for selected one or more of the plurality of document collections and to obtain occurrence frequency of a related phrase similar to the user phrase for the selected one or more of the plurality of document collections to generate a phrase check result; and
a display device configured to display the phrase check result to the user.

2. The system of claim 1, further comprising:
a storage device configured to store the phrase check result as the phrase check request for the user phrase is generated.

3. The system of claim 2, further comprising:
a processor configured to determine whether the phrase check request is previously generated for the user phrase to generate a first determination result,
wherein the phrase check result is generated when the first determination result indicates that the phrase check request is not previously generated for the user phrase.

4. The system of claim 3, further comprising:
a processor configured to determine whether at least one of the plurality of document collections is changed to generate a second determination result,
wherein the phrase check result is generated when the second determination result indicates that at least one of the plurality of document collections is changed even when the first determination result indicates that the phrase check request is previously generated for the user phrase.

5. The system of claim 2, further comprising:
an input device configured to receive a user input which selects one or more categories to be used for the phrase check request,
wherein the selected one or more of the plurality of document collections correspond to the one or more categories being selected by the user.

6. The system of claim 5, further comprising:
a storage device configured to store information defining criteria to be used for evaluating appropriateness of the user phrase or the related phrase; and
a processor configured to determine the appropriateness of the user phrase or the related phrase based on whether the occurrence frequency of the user phrase or the related phrase satisfies the criteria being defined,
wherein the display device is further configured to display the appropriateness of the user phrase or the related phrase to the user.

7. The system of claim 5, further comprising:
an application program configured to create a document, the user phrase being selected from one or more phrases input by the user through the application program; and
a processor configured to cause the application program to replace the user phrase with the related phrase according to a user instruction.

8. A computer readable medium which stores instructions of an application program which uses a computer to perform a method of supporting document creation, the method comprising:
generating a phrase check request for a user phrase according to a user instruction;
obtaining a phrase check result including occurrence frequency of the user phrase for selected one or more of a plurality of document collections and occurrence frequency of a related phrase similar to the user phrase for the selected one or more of the plurality of document collections; and
displaying the phrase check result to the user.

9. The medium of claim 8, wherein the method of supporting document creation further comprises:
storing the phrase check result as the phrase check request for the user phrase is generated.

10. The medium of claim 9, wherein the obtaining a phrase check result comprises:
determining whether the phrase check request is previously generated for the user phrase to generate a first determination result; and
sending a request to obtain the phrase check result,
wherein the sending a request to obtain the phrase check result is performed when the first determination result indicates that the phrase check request is not previously generated for the user phrase.

11. The medium of claim 10, wherein the obtaining a phrase check result further comprises:
determining whether at least one of the plurality of document collections is changed to generate a second determination result,
wherein the sending a request to obtain the phrase check result is performed when the second determination result indicates that at least one of the plurality of document collections is changed even when the first determination result indicates that the phrase check request is previously generated for the user phrase.

12. The medium of claim 9, wherein the method of supporting document creation further comprises:
receiving a user input which selects one or more categories to be used for the phrase check request;
wherein the selected one or more of the plurality of document collections correspond to the one or more categories being selected by the user.

13. The medium of claim 12, wherein the method of supporting document creation further comprises:
storing information defining criteria to be used for evaluating appropriateness of the user phrase or the related phrase;
determining the appropriateness of the user phrase or the related phrase based on whether the occurrence frequency of the user phrase or the related phrase satisfies the criteria being defined; and
displaying the appropriateness of the user phrase or the related phrase to the user.

14. The medium of claim 12, wherein the method of supporting document creation further comprises:
causing the application program to replace the user phrase with the related phrase according to the user instruction, wherein the application program is configured to create a document, the user phrase being selected from one or more phrases input by the user through the application program.

15. A document creation support apparatus, comprising:
a processor configured to generate a phrase check request for a user phrase according to a user instruction;
a processor configured to obtain a phrase check result including occurrence frequency of the user phrase for selected one or more of a plurality of document collections and occurrence frequency of a related phrase similar to the user phrase for the selected one or more of the plurality of document collections;
a storage device configured to store the phrase check result as the phrase check request for the user phrase is generated; and
a display device configured to display the phrase check result to the user.

16. The apparatus of claim 15, further comprising:
a processor configured to determine whether the phrase check request is previously generated for the user phrase to generate a first determination result; and
a processor configured to generate a request to obtain the phrase check result when the first determination result indicates that the phrase check request is not previously generated for the user phrase.

17. The apparatus of claim 16, further comprising:
a processor configured to determine whether at least one of the plurality of document collections is changed to generate a second determination result,
wherein the request to obtain the phrase check result is generated when the second determination result indicates that at least one of the plurality of document collections is changed even when the first determination result indicates that the phrase check request is previously generated for the user phrase.

18. The apparatus of claim 15, further comprising:
an input device configured to receive a user input which selects one or more categories to be used for the phrase check request,
wherein the selected one or more of the plurality of document collections correspond to the one or more categories being selected by the user.

19. The apparatus of claim 18, further comprising:
a storage device configured to store information defining criteria to be used for evaluating appropriateness of the user phrase or the related phrase; and
a processor configured to determine appropriateness of the user phrase or the related phrase based on whether the occurrence frequency of the user phrase or the related phrase satisfies the criteria being defined,
wherein the display device is further configured to display the appropriateness of the user phrase or the related phrase to the user.

20. The apparatus of claim 18, further comprising:
an application program configured to create a document, the user phrase being selected from one or more phrases input by the user through the application program; and
a processor configured to cause the application program to replace the user phrase with the related phrase according to a user instruction.
